(19) United States
(12) Patent Application Publication
(10) Pub. No.: US 2024/0284143 A1
(43) Pub. Date: Aug. 22, 2024

(54) SYSTEM AND METHOD FOR DISCOVERING PEOPLE NEARBY

(71) Applicant: David Aaron Castro, Antioch, TN (US)

(72) Inventor: David Aaron Castro, Antioch, TN (US)

(21) Appl. No.: 18/444,556

(22) Filed: Feb. 16, 2024

Related U.S. Application Data
(60) Provisional application No. 63/446,315, filed on Feb. 16, 2023.

(51) Int. Cl. H04W 4/02; H04L 67/306

(52) U.S. Cl. CPC H04W 4/023; H04L 67/306

(57) ABSTRACT

A system and method for allowing users within a predefined range to discover each other through their Bluetooth Low Energy (BLE) enabled user devices, wherein each device acts as a central and a peripheral. Peripherals broadcast a BLE service that includes at least a first service UUID and a second service UUID. The first service UUID identifies the participation of respective user devices. The second service UUID includes a unique token that uniquely identifies the user device in the system. Centrals periodically scan the peripherals within a predefined range. First, the central, by filtering, verifies the first service UUID to ensure the respective user device is registered with the system and open for discovery. Thereafter, centrals can initiate a process to read the second service UUID. Centrals can then decode the unique tokens and fetch user profiles associated with the unique tokens.

### CROSS-REFERENCE TO RELATED APPLICATIONS

This application claims priority from a U.S. provisional patent application Ser. No. 63/446,315, filed on Feb. 16, 2023, which is incorporated herein by reference in its entirety.

### FIELD OF INVENTION

The present invention relates to a system and method for discovering new people, and more particularly, the present invention relates to a system and method that allows people within a customizable range to discover each other using their BLE-enabled devices.

### BACKGROUND

It is natural for a person to meet and know new people for a variety of reasons. Humans are social beings and always desire to meet and know new people for love, friendship, companionship, belonging, and the like. Various get-togethers, events and the like provide opportunities to meet new people. Similarly, meeting new people for professional networking, making new clients, and promoting businesses are common in the professional world.

The first step in meeting a new person is introduction. Because the person meeting a new person does not know anything about the other person, the introduction step becomes hectic and time-consuming. Often after introduction, the person knows that the other person is not compatible. For example, in professional networking, a person likes to meet new people within their area of interest.

In conferences, the primary reason people attend events is to make connections that improve outcomes in their business, projects, and personal goals. The attendees typically have some targets for new ideal connections that may make their investment worthwhile. However, the Attendees often find only a fraction of the connections they are hoping to meet. This is disappointing for attendees and reduces their interest in attending further such events.

Speakers and sponsors desire to share a special offer from the stage, and if they are permitted to pitch, they are hopeful attendees will access a link, text a number, or run to the back table and sign up. Technology can help people discover new people within their areas of interest in near real-time during a get-together.

Thus, a need is appreciated for a system and method that allows a person to discover new people within a predefined range based on their areas of interest.

The term “user” herein refers to a person who uses his BLE-enabled device which is registered/subscribed to the disclosed system. The BLE-enabled device is also referred to as a user device hereinafter.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for discovering new people within predefined ranges and in near real times.

Another object of the present invention is that the system and method may provide some information about a person before meeting the same.

Still, another object of the present invention is to save a person from hit and trial to find people of desired areas of interest.

A further object of the present invention is that the system and method enhance networking efficiency.

A system and method for allowing users within a predefined range to discover each other through their user devices, wherein each of the user devices is Bluetooth® Low Energy (BLE) enabled, wherein each user device acts as a central and a peripheral. The method comprises broadcasting, by a first user device acting as peripheral, a BLE service comprising a first service UUID and a second service UUID, wherein the first service UUID identifies that the first user device is registered with a system, wherein the second service UUID comprises a unique token, the unique token configured for uniquely identifying the first user device in the system; scanning, periodically, by a second user device acting as central, for peripherals within a predefined range, wherein the predefined range is within a BLE range of the second user device; capturing, by the second user device acting as central, the BLE service broadcasted by the first user device acting as peripheral, by filtering the first service UUID, wherein the first service UUID is used for verifying that the first user device is registered with the system and open for discovery; upon verifying the first user device through the first service UUID, initiating, by the second user device acting as central, a process to read the second service UUID; decoding, by the second user device acting as central, the unique token of the first user device from the second service UUID; and fetching, by the second user device, from the system, a user profile associated with the unique token of the first user device.

In one aspect, the method further comprises broadcasting, by the second user device acting as peripheral, a BLE service comprising a first service UUID and a second service UUID; and scanning, periodically, by the first user device acting as central, for peripherals within a predefined range, wherein the predefined range is within a BLE range of the first user device.

In one aspect, the method further comprises establishing a temporary BLE connection between the first user device acting as peripheral and the second user device acting as central, wherein the second service UUID is read, by the second user device acting as central, from characteristics of the BLE connection. The second service UUID is decoded from the characteristics of the BLE connection when the second service UUID cannot be read from the BLE service due to secure layer or cross-platform incompatibility between the first user device and the second user device.

In one aspect, the first service UUID is a Static Service UUID. The second service UUID consists of Static Service UUID Prefix and the unique token.

In one aspect, the method further comprises presenting a discovery screen on the second user device, by an interface module; and displaying the user profile associated with the unique token of the first user device on the discovery screen.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 is a block diagram showing an advertisement packet, according to an exemplary embodiment of the invention.

FIG. 4 is a flowchart illustrating a BLE broadcasting mechanism, according to an exemplary embodiment of the invention.

FIG. 5 is a flowchart showing the BLE scanning mechanism, according to an exemplary embodiment of the present invention.

FIG. 6 is a flow chart illustrating the internal Connection Retention and Caching mechanism around the BLE Range, according to an exemplary embodiment of the present invention.

FIG. 7 is a flowchart illustrating the connection refresh mechanism for increasing the probability of BLE Service running on the user device in background mode, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe embodiments only and is not intended to be limited to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method that allow users within a predefined range to discover each other using their BLE-enabled devices. The predefined range can be customized but is within the BLE range. A user on his BLE-enabled device can see at least some information about users around him who also have subscribed to the disclosed system, and based on the information, the users can find other users of relevant interest to them and meet them. The information can be presented as a profile wherein a user can modify his profile at any time as and when desired using his user device. Moreover, the updated profile can be updated and published by the system in near time. The system offers the advantage that users within a predefined range can discover each other. This range can be increased or decreased by the user as and when desired. Also, the user may have an option to enable or disable discovery on his user device i.e., to be discovered by other users.

Besides displaying a list of users within a predefined range, a notification can also be sent on the user's device when a user matching predefined criteria enters the predefined range. Thus, the user upon receiving the notification has a chance to quickly be able to walk over and make an introduction to them.

In events, the user with the help of the disclosed system does not have to randomly meet attendees to find an ideal connection. The user can filter that ideal connection on his user device and can walk over and make an introduction to them. The user using the disclosed system can now better utilize their time and can make more connections. Also, any awkwardness can be prevented from meeting people with no common interests.

The user can scan the users in the room for their attributes, enabling them to start a conversation with a particular topic they are comfortable with or use the attributes to provide physical or technology services and APIs to their mobile phone and apps they use, or use the attributes to connect with other users for commercial purposes, for safety, or reporting.

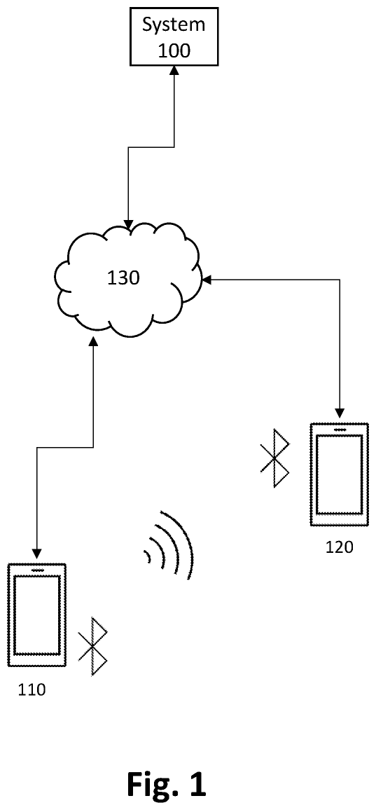

Now referring to FIG. 1, shows an environmental diagram of the disclosed system 100 that can be connected to a first user device 110 and a second user 120 through a network 130. The user device can be a keypad phone, a smartphone, a laptop, a desktop, a tablet computer, a personal digital assistant (“PDA”), and the like. The user device can be Bluetooth® low energy (BLE) enabled. The user device can also include an operating system, such as but not limited to Android, iOS, Windows, macOS, blackberry, and Linux. The user device can have a physical input interface, such as a keypad or touch screen for receiving input and a display to present information received from the system. The user device can also include network circuitry for connecting to network 130. The network circuitry may also support BLE for connecting to other user devices.

The network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. Also, FIG. 1 shows the first and second user devices connected through a single network for illustration purposes only, it is obvious that the different user devices can connect simultaneously or at different times to the disclosed system through different networks and using different network communication protocols. Moreover, the same user device can connect to the disclosed system through more than one network. Also shown in FIG. 1 is the first user device 110 connected to the second user device 120 through a BLE connection.

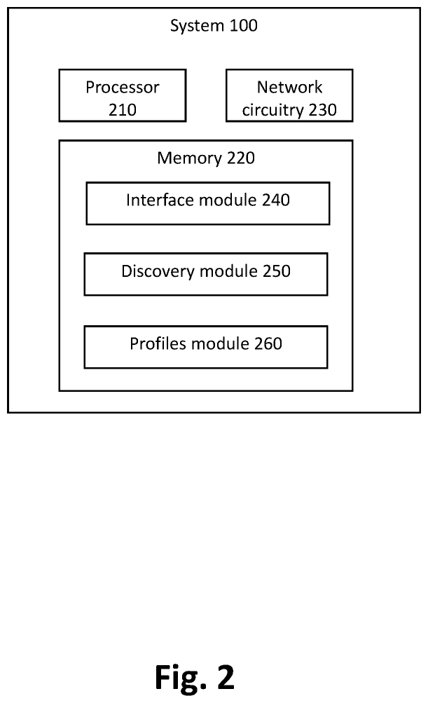

Now, referring to FIG. 2 is a block diagram showing the architecture of the disclosed system 100. System 100 can include a processor 210 coupled to a memory 220 through a suitable system bus. System 100 may also include a network circuitry 230 coupled to the processor 210 through a suitable bus for connecting system 100 to an external network. The processor 210 can be any logic circuitry that responds to, and processes instructions fetched from memory 220. Suitable examples of the processors commercially available include the processors available from Intel®, AMD®, Snapdragon®, Exynos®, MediaTek®, Apple®, and the like. Memory 220 may include one or more memory chips capable of storing data and allowing any storage location to be directly accessed by the processor 210. As shown in FIG. 2, the memory can include modules according to the present invention for execution by processor 210 to perform one or more steps of the disclosed computer-implemented method for discovering users within a predefined range using their user devices. For example, Memory 220 can include an interface module 240, a discovery module 250, and a profiles module 260. The interface module upon execution by the processor can provide an interface on the user device allowing the system to interact with the user. The discovery module, upon execution by the processor, allows users within a predefined range to discover each other using BLE technologies. The profiles modules upon execution by the processor allow for creating profiles of the user and access to the profiles by the user devices.

It is to be understood that all the modules are shown implemented within the disclosed system, however, a skilled person will appreciate that one or more modules can be implemented within the user device. Also, one or more steps of the disclosed methodology can be implemented in the user device.

In certain implementations, the disclosed system can be implemented in the form of one or more servers, the one or more servers include cloud servers. One or more servers can be located at one location or can be geographically dispersed. Moreover, one or more steps of the disclosed methodology can be performed on different servers without departing from the scope of the present invention. Moreover, the system can also be implemented in the user device and/or wearable device.

A person can register with the disclosed system, through their user devices. The person can be provided with login details for secured access to the disclosed system. For example, the person can be provided with a username and password for secure access. Other secured access methods as supported by the user devices can be incorporated without departing from the scope of the present invention. For example, biometrics like face ID and fingerprint can be used.

The disclosed system, through the interface module, can provide an interface on the user's device. The interface may allow a user to interact with the disclosed system through the interface. The interface can be provided as an application software that can be installed on the user device. The application software can be developed for Android™, iOS™, Chrome®, and any other known operating platform for mobile devices. The application software can be made available through a distribution service provider, for example, Google Play™ operated and developed by Google®, and the app store by Apple®. In addition to the application software, a website-based interface can also be provided through the worldwide web. The application software can also be provided for the desktop environment, such as Windows™, Linux, and macOS. The interface may permit interacting with a user through the user device, wherein information can be presented on the user device by the system and information can be received by the system from the user device. Moreover, the interface may allow the user to upload images. The interface may provide step-by-step instructions to register and discover people. The person once registered with the system becomes a user/subscriber of the system.

Through the interface, a system can receive information from the user, wherein the information includes the name and contact details of the user. The information may also include the interests and occupational details of the user. Depending on the interests of the user, a suitable profile can be created. For example, a profile for dating or a profile for professional networking can be created. The user can create multiple profiles, and any profile can be activated by the user anytime. Also, a photograph of the user can be received and included in the profile. The photograph can be used to recognize the user by the others when meeting up. The system can generate a unique token for each user device. The unique token can be used to uniquely identify the device by the system. The profile can be linked with a unique token.

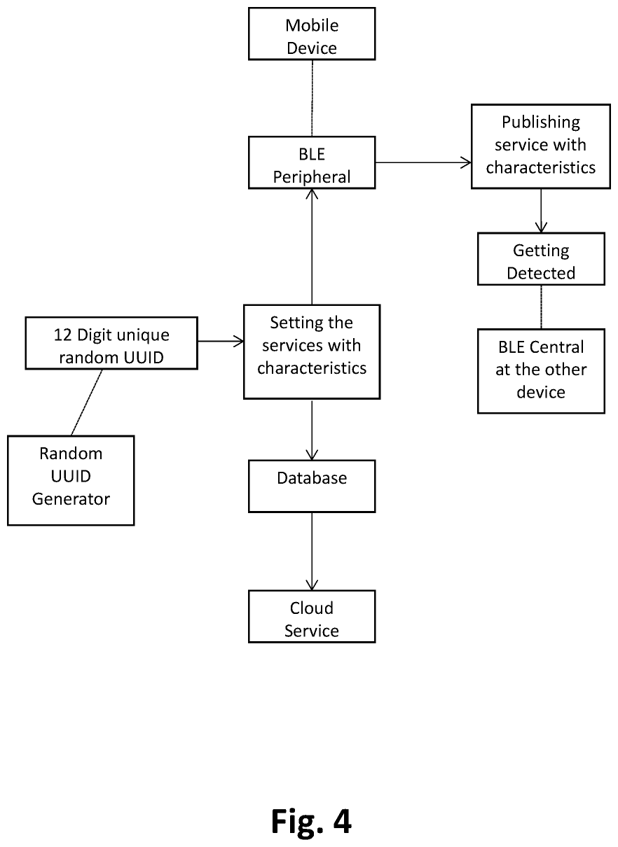

The discovery module is illustrated in FIGS. 4-6, the discovery module can be implemented on the user device and allows the users within a predefined range to discover each other through their user devices.

The user device can discover other user devices within a BLE range using the BLE technologies. The user device can act as both the central and peripheral, wherein acting as a central, the user device can scan other peripherals within the BLE range of the respective user device.

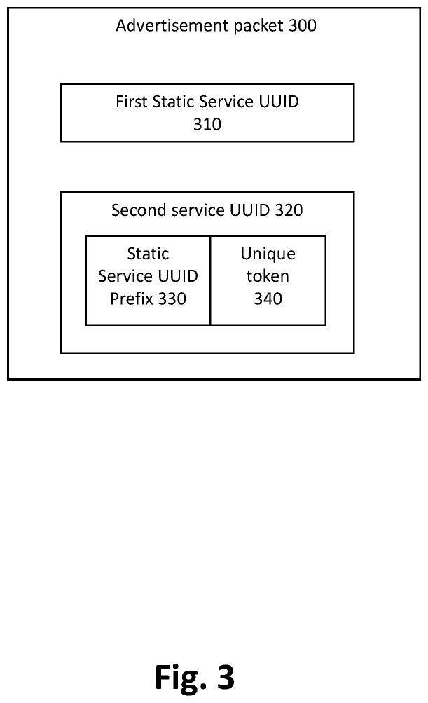

The user device acting as a peripheral can be scanned by the other user devices acting as centrals and within the BLE range of the respective user device. The user device can act both as the central and peripheral at the same time, each identified by a unique identifier. The user device acting as a peripheral can broadcast two service UUIDs as shown in FIG. 3. FIG. 3 shows an advertisement packet 300 broadcasted as a BLE signal/service from a peripheral, the advertisement packet 300 includes a first service UUID 310 and a second service UUID 320. The first service UUID can be a static service UUID that can be common and indicates that the respective user device is registered with the system. Broadcasting of the first service UUID indicates that the respective user device is participating and open to discovery by other user devices. A second service UUID consists of a static service UUID and a unique token of the respective user device. The static service UUID in the second service UUID can be used to filter and extract the unique token.

First, a user device acting as a central can scan other peripherals within the BLE range of the central. The central device can receive the broadcasted BLE advertising signals from the peripherals. The central can then look for, by filtering, the first service UUID. The presence of the first service UUID indicates the registration of the respective peripheral with the system and the user device is participating in the discovery. Those BLE devices not broadcasting the first service UUID can be ignored by the central.

Upon identifying the peripherals having the first service UUID, the central can look for, by filtering, the second service UUID. Upon determining the second service UUID, the discovery module can extract the unique token, the unique token uniquely identifies the respective peripheral. The length of static service UUID and unique token can be predefined and the same can be recognized and extracted based on respective lengths.

In certain implementations, the disclosed method may not be able to decode the unique token from the second service UUID. This could be due to a variety of reasons, such as same-platform communication that has multiple Mobile Vendors and Cross-platform communication between iOS® and Android® applications. BLE technology and people networking are evolving on a day-to-day basis, also the Operating System (OS) facilitates a lot of options for safe and secure communications. However, there can be many challenges/inconsistencies when it comes to same-platform communication that has multiple Mobile Vendors and Cross-platform communication between iOS® and Android® apps.

The disclosed system allows for discovering the same and cross-platform user devices for networking with people in the closed BLE range. The discovery module can effectively use BLE Services and Characteristics to uniquely identify the peripherals. The central can connect with the peripheral and read the unique token from the characteristics.

In certain implementations, the system may require BLE 4.0 and above as a prerequisite for BLE Communication. It involves a Mobile BLE device acting both as Peripheral and Central at the same time for Concurrent Scanning and Advertising. Thus, a user device having the disclosed API can concurrently scan and broadcast BLE signals. Using BLE Services and Characteristics, a unique token for the application can be shared among the BLE devices, which will be decoded by the receiver.

Upon decoding the unique token, the profile module can fetch the profile of the user associated with the unique token from the system. The profile can be downloaded on the user device and can be presented through the interface. The user interface may include a discovery screen. The discovery screen can show the list of users as determined by the central that is within the predefined range. The central can retrieve profiles of all the users within the predefined range and display the same on the discovery screen. For example, the discovery screen may include tiles, each tile for one user. The tiles can show basic information about the user, such as a photograph, name, and area of interest. A tile can be clicked to fetch more information about the respective user. Only information made public by the user may be fetched from the system. The users may have options to mark different information in their profile as public or private. For example, the phone number can be marked private and the same may not be publicly available. The user may have an option to make any information private or public at any time.

The discovery screen may also receive the predefined distance. The predefined distance is the distance within which the user devices are shown on the discovery screen. The predefined distance can be determined based on the BLE signal strength. The predefined distance can be within the BLE signal range of the user device. The user can set the predefined distance in his user device for filtering the user's devices.

The discovery module, through the interface, may also receive one or more keywords from the user. The user device can query these keywords in the profiles of the users identified by the user device as central. When one or more profiles matching the keywords can be found by the central, the central can send a notification to the user. The notification can be presented on the user device.

In certain implementations, disclosed is a method that allows users within a predefined range to discover each other. Referring to FIG. 4, which shows the broadcasting mechanism. A user device acting as a peripheral can send in the data for other BLE Central to receive and decode. Each user device can randomly generate a unique token that can be synchronized with the system. Or the unique token can be generated by the system and assigned to the user device. The unique ID can identify the user device in the system. The method includes setting the Peripheral Manager with Service (two Service UUIDs) and Characteristics which contains generated Service UUIDs, property as indicated, and permission as Readable. The Peripheral Manager advertises the services and characteristics. Based on the service UUID, the advertised services get captured by the Central Manager on the other user devices.

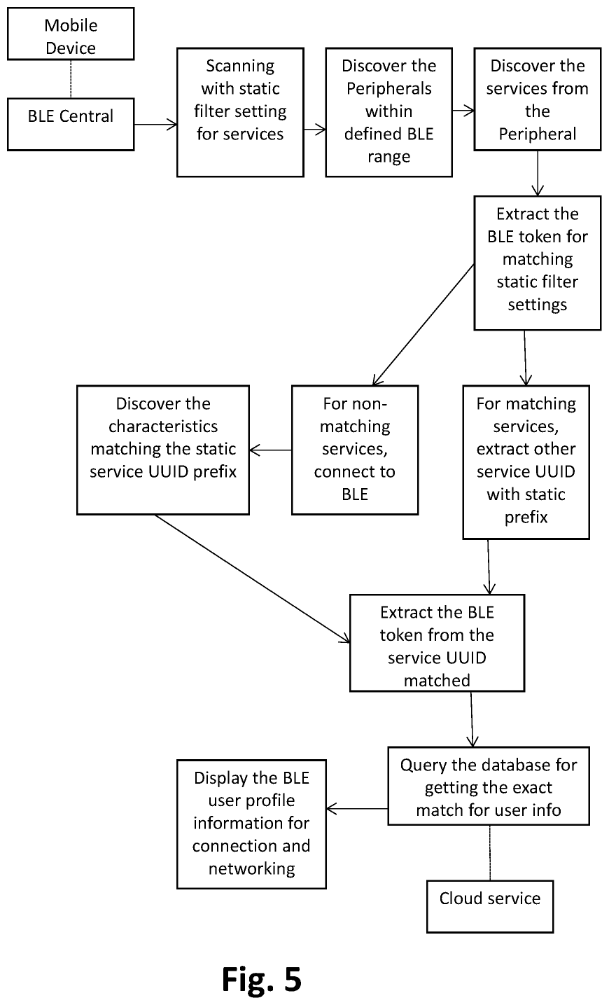

Referring to FIG. 5 which illustrates the scanning mechanism by the central. A user device acts as a central to receive and decode the data from other peripherals. The BLE central scans the BLE devices with the Static Service UUID of the application to filter the specific devices having the application according to the present invention installed. The central can filter out the BLE devices within a specific BLE range (a few meters as set in the application). The central can then extract the available services from the discovered Peripherals. Then, the central can decode the service matching the Static Service UUID Prefix (21 digits). Upon decoding, extract the Service UUID from the matching Service. If the Matching Service is not available, in the case of Cross Platform data sharing, the central gets connected to the Peripheral to discover the characteristics. The central can then check if the characteristics contain data with Static Service UUID Prefix, if so, extract the Service UUID from the characteristics. Once the process is done, the central can be disconnected from the Peripheral. Thereafter, extracting the application token (unique token) from the Service UUID matched. The application token and the Static Service UUID Prefix can be of fixed predetermined lengths. The application token for the Peripheral ID can then be cached to avoid rediscovery and reconnection. Thereafter, the central can query the cloud database using the application token to get the details of the User. The User details can then be presented on the discovery screen.

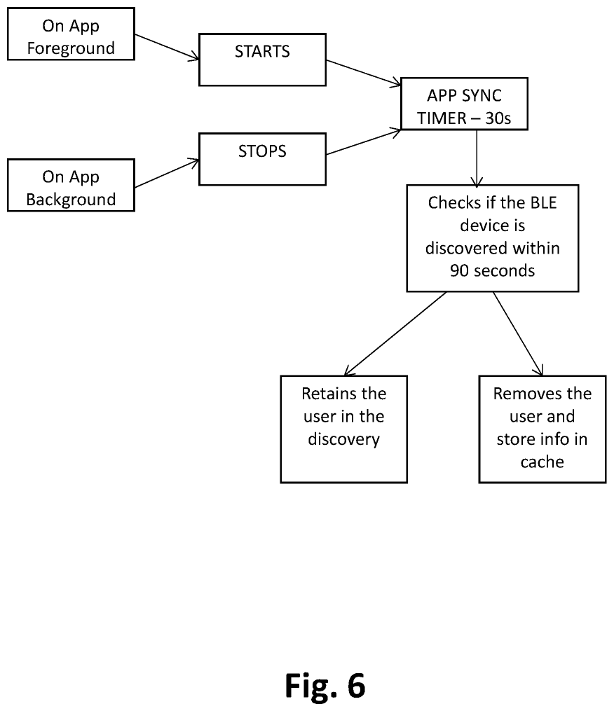

FIG. 6 illustrates the connection retention mechanism to be followed to retain the users in the BLE discovery screen. Whenever the application on the user device comes to the foreground mode, the timer starts running to execute a task every 30 seconds. When the app goes to the background, a timer gets stopped. According to scanning results of the BLE Central, all the discovered user devices within the BLE range get updated with their last discovered timestamp information. The timer task checks whether the last discovered timestamp is above the threshold time interval (defined in the application, for example, 90 seconds). If the discovered timestamp is well within the threshold time interval, the user gets retained on the BLE discovery screen. If the discover timestamp is outside of the threshold time interval, the user gets removed from the BLE discovery screen.

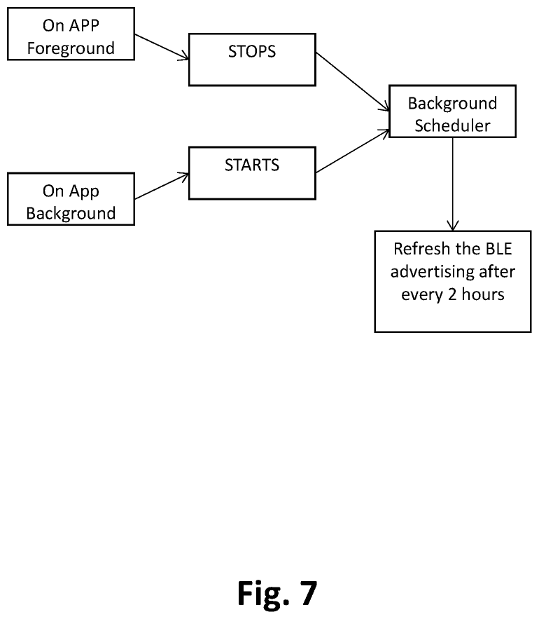

Referring to FIG. 7 shows the connection refresh mechanism for increasing the probability of BLE Service running on the application in background mode. Whenever the application on the user device goes to background mode, the background schedular starts running executing a task roughly every two hours depending on various OS Environment features. It is understood that the duration can be varied without departing from the scope of the present invention. Whenever the application on the user device goes to the foreground mode, the background schedular gets stopped. Background schedular task refreshes the BLE Peripheral advertising by restarting with the same services and characteristics in the background.

While these various embodiments are described in sufficient detail to enable those skilled in the art to practice the disclosure, it should be understood that other embodiments may be realized, and that logical and mechanical changes may be made without departing from the spirit and scope of the disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for allowing users within a predefined range to discover each other through their user devices, wherein each of the user devices is Bluetooth® Low Energy (BLE) enabled, wherein each user device acts as a central and a peripheral, wherein the method comprises:
broadcasting, by a first user device acting as peripheral, a BLE service comprising a first service UUID and a second service UUID, wherein the first service UUID identifies that the first user device is registered with a system, wherein the second service UUID comprises a unique token, the unique token configured for uniquely identifying the first user device in the system;
scanning, periodically, by a second user device acting as central, for peripherals within a predefined range, wherein the predefined range is within a BLE range of the second user device;
capturing, by the second user device acting as central, the BLE service broadcasted by the first user device acting as peripheral, by filtering the first service UUID, wherein the first service UUID is used for verifying that the first user device is registered with the system and open for discovery;
upon verifying the first user device through the first service UUID, initiating, by the second user device acting as central, a process to read the second service UUID;
decoding, by the second user device acting as central, the unique token of the first user device from the second service UUID; and
fetching, by the second user device, from the system, a user profile associated with the unique token of the first user device.

2. The method of claim 1, wherein the method further comprises:
broadcasting, by the second user device acting as peripheral, a BLE service comprising a first service UUID and a second service UUID; and
scanning, periodically, by the first user device acting as central, for peripherals within a predefined range, wherein the predefined range is within a BLE range of the first user device.

3. The method of claim 1, wherein the method further comprises:
establishing a temporary BLE connection between the first user device acting as peripheral and the second user device acting as central, wherein the second service UUID is read, by the second user device acting as central, from characteristics of the BLE connection.

4. The method of claim 3, wherein the second service UUID is decoded from the characteristics of the BLE connection when the second service UUID cannot be read from the BLE service due to secure layer or cross-platform incompatibility between the first user device and the second user device.

5. The method of claim 1, wherein the first service UUID is a Static Service UUID.

6. The method of claim 5, wherein the second service UUID consists of Static Service UUID Prefix and the unique token.

7. The method of claim 1, wherein the method further comprises:
presenting a discovery screen on the second user device, by an interface module; and
displaying the user profile associated with the unique token of the first user device on the discovery screen.

8. A system for allowing users within a predefined range to discover each other through their user devices, wherein each of the user devices is Bluetooth® Low Energy (BLE) enabled, wherein each user device acts as a central and a peripheral, wherein the system is configured to implement a method comprising:
broadcasting, by a first user device acting as peripheral, a BLE service comprising a first service UUID and a second service UUID, wherein the first service UUID identifies that the first user device is registered with the system, wherein the second service UUID comprises a unique token, the unique token configured for uniquely identifying the first user device in the system;
scanning, periodically, by a second user device acting as central, for peripherals within a predefined range, wherein the predefined range is within a BLE range of the second user device;
capturing, by the second user device acting as central, the BLE service broadcasted by the first user device acting as peripheral, by filtering the first service UUID, wherein the first service UUID is used for verifying that the first user device is registered with the system and open for discovery;
upon verifying the first user device through the first service UUID, initiating, by the second user device acting as central, a process to read the second service UUID;
decoding, by the second user device acting as central, the unique token of the first user device from the second service UUID; and
fetching, by the second user device, from the system, a user profile associated with the unique token of the first user device.

9. The system of claim 1, wherein the method further comprises:
broadcasting, by the second user device acting as peripheral, a BLE service comprising a first service UUID and a second service UUID; and
scanning, periodically, by the first user device acting as central, for peripherals within a predefined range, wherein the predefined range is within a BLE range of the first user device.

10. The system of claim 8, wherein the method further comprises:
establishing a temporary BLE connection between the first user device acting as peripheral and the second user device acting as central, wherein the second service UUID is read, by the second user device acting as central, from characteristics of the BLE connection.

11. The system of claim 10, wherein the second service UUID is decoded from the characteristics of the BLE connection when the second service UUID cannot be read from the BLE service due to secure layer or cross-platform incompatibility between the first user device and the second user device.

12. The system of claim 8, wherein the first service UUID is a Static Service UUID.

13. The system of claim 12, wherein the second service UUID consists of Static Service UUID Prefix and the unique token.

14. The system of claim 8, wherein the method further comprises:
presenting a discovery screen on the second user device, by an interface module; and
displaying the user profile associated with the unique token of the first user device on the discovery screen.

15. A method for allowing users within a predefined range to discover each other through their user devices, wherein each of the user devices is Bluetooth® Low Energy (BLE) enabled, wherein each of the user devices acts as a central and a peripheral, wherein the method comprises:
broadcasting, by each of the peripherals, a BLE service comprising a first service UUID and a second service UUID, wherein the first service UUID identifies that the respective user device is registered with a system, wherein the second service UUID comprises a unique token, the unique token uniquely identifies each of the user devices in the system;
scanning periodically, by the centrals, for other peripherals within predefined ranges, wherein the predefined ranges are within a BLE range of respective central;
capturing, by the centrals, the BLE services broadcasted by the other peripherals, by filtering the first service UUID, wherein the first service UUID is used for verifying that the respective peripheral is registered with the system and open for discovery;
upon verifying the other peripherals through the first service UUID, initiating, by the centrals, a process to read the second service UUIDs;
decoding, by the centrals, the unique tokens of the other peripherals from their second service UUIDs; and
fetching, by the centrals, from the system, user profiles associated with the unique tokens of the other peripherals.
